(19) United States
(12) Patent Application Publication
(10) Pub. No.: US 2003/0223112 A1
(43) Pub. Date: Dec. 4, 2003

(54) Telescope

(76) Inventor: Alfred Weissenbacher, Waidhofen a.d. ybbs (AT)

Correspondence Address: FRIEDRICH KUEFFNER, P.C., PATENT AND TRADEMARK ATTORNEY, 317 MADISON AVENUE, SUITE 910, NEW YORK, NY, 10017, US

(21) Appl. No.: 10/402,325

(22) Filed: Mar. 28, 2003

(30) Foreign Application Priority Data
Apr. 3, 2002 (AT) A 512/02

(51) Int. Cl. G02B 23/00

(52) U.S. Cl. 359/399

(57) ABSTRACT

A telescope includes at least two telescope components which are constructed C-shaped and/or U-shaped and are arranged so as to be longitudinally slidable relative to each other. The telescope components are movable by the longitudinal displacement between a retracted position and an extended position. The telescope components are separated from each other by rolling bodies which ensure the slidability of the components. The rolling bodies may be guided in a cage and travel on tracks of the telescope components which are limited by stops, screws or the like. A stop is provided in the area of a travel path of the rolling bodies between the end portions of the track.

### BACKGROUND OF THE INVENTION

1. Field of the Invention

The present invention relates to a telescope with at least two telescope components which are constructed C-shaped and/or U-shaped and are arranged so as to be longitudinally slidable relative to each other. The telescope components are movable by the longitudinal displacement between a retracted position and an extended position. The telescope components are separated from each other by rolling bodies which ensure the slidability of the components. The rolling bodies may be guided in a cage and travel on tracks of the telescope components which are limited by stops, screws or the like.

2. Description of the Related Art

A telescope of the above-described type in the form of a guide rail is disclosed in DE 196 50 698 A1. The stops serve to limit the mobility of the telescope components relative to each other and thereby prevent a collapse of the telescope; however, since the stops protrude into the track of the rolling bodies, they also prevent the rolling bodies from rolling out of the telescope at the end of the track.

U.S. Pat. No. 1,963,220 A discloses a pull-out mechanism for a drawer having a similar construction. U.S. Pat. No. 4,089,568 A and JP 03-169 755 A also discloses similar constructions. In all of these cases, the stops have the purpose of preventing the rolling bodies from rolling out of the telescope and, therefore, the stops are essentially located at the end of the track or tracks.

U.S. Pat. No. 4,556,263 A does not relate to a telescope, but to a carriage. A lower component is mounted so as to be stationary, for example, in the travel direction of a vehicle, and an upper component which supports a seat can be moved between a position in which the upper component is partially behind the lower component and a position in which the upper component is located partially in front of the lower component. Stops protruding from each of the carriage components into the track of the rolling bodies have a special purpose; the stops are supposed to limit through the rolling bodies the mobility of the carriage components which facilitate the sliding movement of the seat. In such a carriage, a direct contact between the two carriage components is not possible because of the fact that the upper component travels on both sides across the lower component. In order to lower the destructive impact load which each time acts on the rolling bodies, a resilient element is provided between the rolling bodies. Even though the impacts take place relatively infrequently, these measures are necessary because the impacts take place with a significant force.

Telescopes have been generally known in the prior art for a long time. Their original and still primary use is to be able to extend rod-shaped structures as necessary in order to move objects located at the tip as far as possible from the base. Typical fields of application are tripods for devices of all types, cantilevers of cranes, ladders, fishing rods and the like. These fields of application make it possible to construct the individual components of the telescope as a hollow cylinder, but not necessarily with a circular cross-section, and to arrange the individual components within each other. This construction as a closed hollow section makes it possible to achieve a great stiffness and, in turn, this makes it possible in many fields of application that the telescoping components slide directly on each other without having to provide rolling bodies between the components.

In telescoping support or holding rails, as they are used for the above-mentioned object, it is unavoidable that the telescope is subjected to high forces transversely of the telescope axis during the retracting and extending movements. In addition, these forces are of a dynamic nature and not of a static nature, so that the loads acting on the telescope are extremely high. Furthermore, because of the necessity to connect, albeit movably, one of the end components of the telescope to the rail car body and to attach the door leaf to the other end component of the telescope, it is not possible to provide these components with a closed cross-section; rather, all of the components with the exception of one must be constructed with a slot either C-shaped or only U-shaped.

Because of these considerations, it is not possible to support these telescope components directly relative to each other. Rather, it is necessary to provide rolling bodies in order to prevent wear which would occur during a sliding friction. However, the use of these rolling bodies results in difficulties with respect to complexity and impairment of operation of the telescope which are virtually the same as those eliminated by the use of the rolling bodies.

The rolling bodies are guided in cages which essentially have the cross-section which corresponds to the gap between two adjacent telescope components; thus, the cross-section is essentially U-shaped. This U-shaped cross-section makes it necessary to provide the gap with such a width that enough space remains for the cage. Consequently, the individual webs, or actually the center planes thereof, must have a distance between each other which is greater than would be necessary as a result of the configuration of the telescope; this, in turn, results in buckling and bending moments which increase the deformation of the individual telescope components.

In addition, for reasons of cost and space, the rolling bodies can practically only be constructed as balls which travel in V-shaped grooves arranged at the inner sides of the legs of the outer telescope component and the outer side of the legs of the adjacent inner telescope component. Even if practically no deformation of the telescope components were to occur, rolling of the balls is not possible under these circumstances, i.e., contact at four points of the ball surface, without sliding at least at one of the contact points. Together with the above-described deformations and impacts and vibrations, grinding movements of the rolling bodies occur which lead to an extreme wear of the rolling tracks as well as of the rolling bodies.

This wear may even have the result that, in vehicle doors with such telescopes in the closed state of the door during the movement of the vehicle, the balls roll along the grooves depending on the acceleration or deceleration state of the vehicle, because the tracks and/or balls have been worn down to such an extent that they are seated completely loosely. The balls then no longer provide a uniform support. The movement of the telescope becomes stiff and unsafe. Moreover, the loads cause the cages to be ground down, so that an inspection of the door reveals individual freely rolling balls and hardly a trace of a cage.

All of these facts have the result that the service life of such telescopes is entirely unsatisfactory and the use thereof is expensive and causes problems because of the unreliability of the telescope.

### SUMMARY OF THE INVENTION

Therefore, it is the primary object of the present invention to provide a telescope of the above-described type which does not have the disadvantages described above and which in particular ensures a better relative movement of the telescope components, and an improved reliability and service life without increasing the manufacturing and/or maintenance costs.

In accordance with the present invention, a stop is provided in the area of a travel path of the rolling bodies between the end portions of the track.

This stop arranged at a distance from the end of the track prevents in the retracted position of the telescope that the rolling bodies can travel beyond their predetermined end position. The optimum spacing of the stop from the end of the respective track depends, as will be explained in more detail below, on the ratio of the length of the telescope components to the length of the distance by which the telescope components are extended; in the “classical” configuration, i.e., in telescope components which can be moved practically completely into one another and with the greatest possible distance of extension, the spacing is ⅓ of the length of the telescope components.

In this manner, the rolling bodies are positioned during each closing of the door; this which ensures that when the door is opened the rolling bodies are located in that section between the adjacent telescope components in which they are required for transmitting the forces. The present invention is based on the finding that the movement of the rolling bodies occurring primarily during the closed state of the door, i.e., usually during the movement of the rail vehicle, is harmful to the service life of the telescope.

The stop must be provided on each telescope component in such a way that, when the door is closed, no longitudinal forces are transmitted between the telescope components through the rolling bodies; the rolling bodies must be held with little but sufficient play in their predetermined position. At the limitation for the movement of the telescope components relative to each other may be a separate stop and/or the closing end position of the door leaf. Nevertheless, the stop for the rolling bodies may be elastic in order to prevent impact and the resulting noise.

Since the rolling bodies are displaced by half the distance of the displacement of the corresponding telescope components, the entire displacement distance is divided into thirds with respect to their operation, while fully kinematically utilizing the length of the telescope components; in the fully extended position, the rolling bodies are located in that area in which the telescope components overlap each other. This area has a length of one third of the overlapping area of the two telescope components. In the fully retracted position, the telescope components have been displaced by two thirds of the length of the overlapping area and the rolling bodies have traveled by a third and are now located in the middle third which they occupy essentially entirely.

The stops must be provided in such a way that, during the travel of the vehicle when the telescope is in the fully retracted position, the rolling bodies cannot travel out of the middle third of the length of the telescope.

In accordance with a further development of the invention, instead of a cage with C-shaped cross-section, two separate cages are provided for the two track areas or for the rolling bodies and the webs of the telescope components are arranged closer together in order to reduce the torsion and buckling forces. It has been found that at the regular positioning of the rolling bodies makes it possible to omit a coupling of the two groups of rolling bodies which are actually independent of each other without a decrease in the service life of the telescope as a result.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a schematic view of a telescope according to the present invention shown in the fully extended position;

FIG. 2 shows the telescope of FIG. 1 in a partially retracted position;

FIG. 3 shows the telescope of FIG. 1 in the fully retracted position; and

FIG. 4 is a sectional view of a telescope according to the present invention, similar to FIGS. 1-3, except that the telescope has not two but three components.

### DETAILED DESCRIPTION OF THE INVENTION

FIGS. 1-3 show a telescope denoted in its totality with reference numeral 1. This telescope 1 is composed essentially of an inner telescope rail 2 and an outer telescope rail 3. The two rails do not slide on each other, but are guided and supported by rolling bodies 4, so that during the regular operation, i.e., retracting movements and extending movements, no sliding friction occurs, but only rolling friction.

FIG. 1 shows that, in the fully extended position of the two telescope components 2, 3, the rolling bodies 4 are located in the remaining section occupied by both telescope components, so that the forces to be transmitted through the telescope are transmitted through the rolling bodies in this section.

In order to be complete, it should be pointed out that, in the fully extended position of the telescope, already in the prior art this limitation of the space for the rolling bodies automatically results in a certain alignment of the rolling bodies because the adjacent telescope components are extended to such an extent that just enough space remains in the overlapping area for accommodating the rolling bodies. However, this alignment is without influence on the service life because rattling movements, accelerations, decelerations or vibrations do not occur when the door is open, and even if these were to occur, there would be no room for the rolling bodies to be displaced.

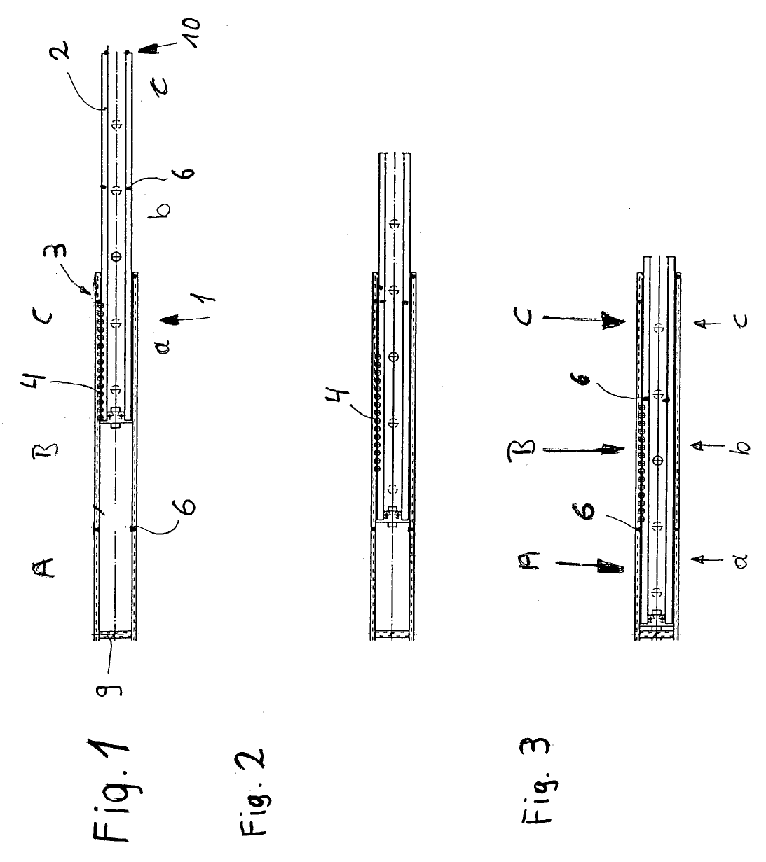

As can be seen in FIG. 2, when the telescope is retracted, the rolling bodies 4 move at half the rate of the two telescope components so that the rolling bodies are always located by the same distance from the open end of the outer telescope component and from the closed end of the inner telescope component.

When this movement is continued, the position shown in FIG. 3 is reached: the two telescope components 2, 3 are fully retracted and the rolling bodies 4 are completely located in the middle third or middle section because the rolling bodies may only be provided over a shorter portion of the length of the telescope components if the forces to be transmitted permit this.

FIG. 3 shows for each of the two telescope components three sections, i.e., the sections A, B, C for the outer telescope rail 3 and a, b, c for the inner telescope rail 2. When comparing FIG. 1 to FIG. 3, it can be seen that there are never any rolling bodies in the section A of the outer telescope rail and, similarly, there are never any rolling bodies in the section c of the inner telescope rail 2. Depending on the position of the telescope components relative to each other, the rolling bodies are always only in the two other sections, i.e., in the sections B and C of the outer telescope rail 3 and in the sections a and b of the inner telescope rail 2.

The lengths of the sections A and C and, thus, also the lengths of the sections a and c correspond to half the maximum length of the extension of the two telescope components relative to each other, and the lengths of the sections B or b correspond to the length between the “frontmost” and “rearmost” rolling body, i.e., the length being occupied by rolling bodies. All of these lengths are not to be understood in the precise mathematical sense as from “center point to center point” but practically, i.e., taking into consideration the cage, the closing components, the excess lengths, etc. For example, it is possible that the outer telescope rail 3 is constructed longer on the closed side than shown in the drawing, so that the length of the section A would be longer than half the extending distance; the positions and lengths of the sections can actually only be defined as a function of the telescope.

Thus far, the manner of operation and kinematics of a functioning telescope with rolling bodies has been explained with the aid of FIGS. 1-3. In the problem cases referred to above, damage to the tracks and/or the rolling bodies lead to the result that, in the closed position of the telescope as it is shown in FIG. 3, the rolling bodies 4 can move during the travel of the rail vehicle relatively freely along the rolling tracks and can assume a completely undefined position in the direction of the telescope axis between the telescope components. When the door drive is then actuated when the vehicle stands still, the completely undefined arrangement of the rolling bodies, particularly when the cage provided between the rolling bodies has already been destroyed, causes the telescope components to be moved apart more or less forcibly, wherein each rolling body, which is located at the beginning outside of the section B, which by definition corresponds to section b, is subjected to sliding friction at the beginning or the end of the extending movement.

Moreover, the resulting extreme wear drastically reduces the quality of the geometric accuracy of the telescope which, in turn, has a damaging effect on the door drive.

In accordance with the invention, stops are provided on the tracks of the outer telescope rail 3 in the area of the transition between the sections A and B and on the tracks of the inner telescope rail 3 in the area of the transition between the sections b and c, wherein the rolling bodies 4 cannot move past these stops without being destroyed.

The stops may be of various types: worm screws may be provided which protrude from the outside into the area of the tracks; the stops may be stop devices with special contact surfaces for the rolling bodies. Finally, the stops may be obstacles which are screwed, clamped, riveted, glued, soldered or welded into the tracks.

It must be mentioned in this connection that completely surprisingly the mounting of such stops only in the outer telescope rail 3 is already sufficient for significantly increasing the service life of the entire telescope. This means that, in the two-component telescope illustrated in FIGS. 1-3, it is sufficient to provide such a stop in the area of the tracks of the outer telescope rail 3 between the sections A and B. Of course, the effect is further improved, as already mentioned, if such a stop is also provided at the transition of the sections b, c of the inner telescope rail 2.

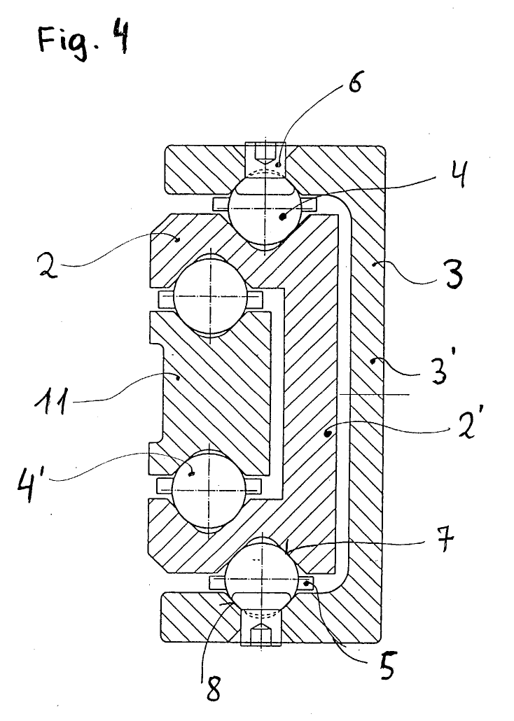

FIG. 4 shows an embodiment of the invention in a cross-section perpendicularly of the telescope axis. The telescope shown in FIG. 4 has three components. In the following, the outermost telescope component is still referred to by reference numeral 3 and the adjacent (actually middle) telescope component is referred to as the inner telescope component 2. The innermost or central telescope component 11, which has a different cross-sectional shape as compared to the outer and inner telescope components, is shown primarily for explaining various possibilities and developments of the invention.

As clearly illustrated in FIG. 4, the rolling bodies, which are almost exclusively balls, travel in V-shaped grooves with sides 7 and 8. This means that each rolling body 4 is contacted at four points by four tangential planes which is statically overdetermined and is responsible for many of the above-described problems and disadvantages. Another problem is the fact that, in relation to the rolling axis of the rolling bodies 4, the points of contact of the rolling bodies with the tangential planes almost have the same radius because otherwise an exclusive rolling movement of the rolling bodies on the two tracks would be impossible.

Since, moreover, the individual rolling bodies 4 are held in their position through a cage 5, the requirement mentioned last must not only be met for each individual rolling body, but also simultaneously and during the entire movement for all rolling bodies.

As a consequence of these boundary conditions which are impossible to meet, sliding occurs between the rolling bodies and the tracks, which leads to sliding friction and, thus, to deformations and/or abrasions. However, these deformations do not result in an equalization and, thus, reduction of the problems, but to an increase and build-up thereof.

As already mentioned, these problems can be eliminated by providing the stops 6 according to the present invention, wherein FIG. 4 shows two of the stops in the outer telescope rail 3. In the illustrated embodiment, the stops are screws screwed into the telescope components, however, as already mentioned, any other shape may be selected for the stops, particularly if an elastic deceleration of the rolling bodies contacting the stop is to be ensured.

FIG. 4 also makes it clear that it is possible as a result of the invention that the two rows of rolling bodies between the two telescope components are each provided with their own cage 5 and that it is not necessary to connect the two cages 5 with each other in the gap between the outer telescope component 3 and the inner telescope component 2. In this manner, it is possible to arrange the webs 3′ and 2′ closer together and, thus, to reduce the buckling and bending loads acting on the telescope components because the loads are located closer to the telescope axis and, therefore, act with a shorter lever arm.

FIG. 4 also shows a central telescope component 11. The relationships between the inner telescope component 2 and the central telescope component 11 are identical to those between the outer telescope component 3 and the inner telescope component 2, so that no further explanations are required. For this reason, no stop is shown in these two telescope components. These stops must be provided in the same manner as illustrated in FIG. 4 in connection with the outer telescope component 3.

Of course, particularly in the case of a two-leaf door, it is possible to provide a single continuous outer telescope component in which two inner telescope components are slidably arranged, wherein each inner telescope component is extendable to one of the sides. However, this configuration does not change the manner of operation of the stops according to the present invention; the above-mentioned positions and length relationships also remain the same as in the example explained above, wherein only one of the telescope sides must be considered.

The invention is not limited by the embodiments described above which are presented as examples only but can be modified in various ways within the scope of protection defined by the appended patent claims.

I claim:

1. A telescope comprising
at least two telescope components having a C-shaped or U-shaped cross-section, wherein the telescope components are longitudinally movable relative to each other between a retracted position and an extended position,
rolling bodies separating the telescope components traveling in tracks of the telescope components, wherein the rolling bodies travel along track sections limited by stops, wherein
at least one stop for the rolling bodies is arranged at a distance from an end portion of a track.

2. The telescope according to claim 1, wherein the rolling bodies traveling on a track are guided by a cage.

3. The telescope according to claim 1, wherein the stop has a distance from an end of the track equal to 20 to 33% of a maximum length of extension of an adjacent telescope component.

4. The telescope according to claim 3, wherein the stop has a distance from an end of the track equal to 25 to 30% of a maximum length of extension of an adjacent telescope component.

5. The telescope according to claim 1, wherein the stop is comprised of a screw screwed into the telescope component.

6. The telescope according to claim 1, wherein the stop is configured as an elastic stop.

7. The telescope according to claim 1, wherein the outer telescope component comprises an inner length section, a middle length section and an outer length section, wherein the rolling bodies are located in the middle length section in the retracted position of the telescope components and in the outer length section in the extended position of the telescope components, wherein the stop is located at an end of the middle length section in an area of transition to the inner length section, and wherein the outer length section has a length equal to essentially half a maximum extended length of the telescope components and the middle length section has a length equal essentially to a length of the telescope component occupied by rolling bodies.

8. The telescope according to claim 8, wherein the inner telescope component comprises an inner length section, a middle length section and an outer length section, wherein the rolling bodies are located in the middle length section in the retraced position of the telescope components and in the inner length section in the extended position of the telescope components, wherein the stop is located at an end of the middle section in an area of transition to the outer length section, and wherein a length of the inner length section is essentially equal to half a maximum distance of extension of the telescope components and the length of the middle length section is equal essentially to a length of the telescope component occupied by rolling bodies.

9. The telescope according to claim 2, wherein a separate cage is provided for the rolling bodies traveling in each track.

10. The telescope according to claim 1, wherein the telescope has three telescope components, wherein an outer telescope component and an inner telescope component adjacent the outer telescope component have a C-shaped or U-shaped cross-section and a central telescope component adjacent the inner telescope component has an essentially rectangular cross-section.
